(19) United States
(12) Patent Application Publication
(10) Pub. No.: US 2020/0162022 A1
(43) Pub. Date: May 21, 2020

(54) METHOD FOR OPERATING A HYBRID COLLECTOR SOLAR SYSTEM

(71) Applicant: SOBLUE AG, Zurich (CH)

(72) Inventor: Dritan Ramani, Zurich (CH)

(21) Appl. No.: 16/618,761

(22) PCT Filed: Jun. 1, 2018
(86) PCT No.: PCT/CH2018/050018

§ 371 Date: Dec. 2, 2019

(30) Foreign Application Priority Data
Jun. 2, 2017 (CH) 00710/17

(51) Int. Cl. H02S 40/44; F24S 10/00; F24S 40/60; F24S 50/40; F24S 60/30; F24S 40/58; F24S 80/30; F24S 20/00; F24D 11/00; F24D 11/02

(52) U.S. Cl. CPC H02S 40/44; F24S 10/00; F24S 40/60; F24S 50/40; F24D 11/0221; F24S 40/58; F24S 80/30; F24S 2020/17; F24D 11/003; F24S 60/30

(57) ABSTRACT

A method for operating a hybrid collector solar system includes a heat transfer agent, which is present in a buffer accumulator, that passes via a pump into a thermal solar collector of the hybrid collector in order to heat the heat transfer agent. The pump is connected into a feed line that connects the buffer accumulator to the thermal solar collector. The hybrid collector solar system is partially filled with the heat transfer agent so that part of the hybrid collector solar system is not filled and so that the heat transfer agent is moved back and forth between the thermal solar collector and the buffer accumulator via the feed line depending on its temperature, thereby realizing an oscillating method of operation.

### CROSS-REFERENCE TO RELATED APPLICATIONS

This application is a national phase entry under 35 U.S.C. § 371 of PCT/CH2018/050018 filed Jun. 1, 2018, which claims priority to Swiss Patent Application No. 00710/17 filed Jun. 2, 2017, the entirety of each of which is incorporated by this reference.

### BACKGROUND

### Field of the Invention

The invention relates to a method for operating a hybrid collector solar system and a hybrid collector solar system to carry out the method.

### Prior Art

Hybrid collectors are known in the prior art. These utilize sunlight more efficiently than a photovoltaic module or a thermal solar collector (also called a sun collector or flat collector) by themselves. For photovoltaic modules (PV modules), it is a general rule that their power diminishes with rising temperature. One therefore tries to maintain the temperature of the PV modules as low as possible. Now, the synergistic effect of hybrid collectors is that these collectors have heat exchangers which cool the PV modules. The heat taken away via the heat exchanger can be used, for example, for hot water purposes, heating assistance, or heat pump assistance. The overall efficiency of hybrid collectors is accordingly higher than the efficiency of a PV module or a solar collector by themselves.

The hybrid collector is integrated in a heating circuit in that a heat transfer agent is constantly circulated. Furthermore, a buffer accumulator and a pump are connected into the heating circuit. The heating circuit is entirely filled with the heat transfer agent. The heat transfer agent is constantly warmed by the circulation. However, pressures of up to 6 bar may build up in the closed circuit. The solar system must therefore be designed and dimensioned accordingly to withstand these pressures. This necessarily results in large capital costs. In addition, leakage and the associated maintenance expense repeatedly occur. Moreover, the continual flow of the heat transfer agent through the thermal solar collector forms dead zones. That is, certain sites within the thermal solar collector are not exchanged by the heat transfer agent. This reduces the efficiency of the solar system and may even lead to hot spots.

### THE PROBLEM OF THE INVENTION

The drawbacks of the described prior art have resulted in the problem to be solved by the present invention, which is to improve a method of this kind for the operation of a hybrid collector solar system such that the capital and maintenance costs of the solar system are reduced and its operating efficiency is improved at the same time.

### SUMMARY

The solution of the stated problem is obtained in a method for operating a hybrid collector solar system in that the solar system is partially filled with heat transfer agent so that part of the solar system is not filled and so that the heat transfer agent is moved back and forth between the thermal solar collector and the buffer accumulator via the feed line in dependence on its temperature, thereby realizing an oscillating method of operation.

Because the solar system is only partly filled with heat transfer agent, enough space remains open so that the heat transfer agent can freely expand upon heating, without building up a pressure in the solar system. This is especially advantageous in hybrid collector, as these may contain pressure-sensitive glass plates.

Because the solar system is partly filled, space is available in the solar system to move the heat transfer agent back and forth between the buffer accumulator and the thermal solar collector. This oscillating operating mode results in a surprisingly high efficiency, since the solar warmth transferred to the heat transfer agent in total is almost as large as that of a heat transfer agent which is continuously moved in a circuit. Furthermore, the energy demand of the pump is reduced as compared to a circulating mode of operation, since the pump only needs to pump the heat transfer agent from the buffer accumulator to the thermal solar collector in defined intervals of time and stands still for the rest of the operating time.

The heat transfer agent in a first operating state is basically located in the buffer accumulator and in a second operating state it is located basically in the thermal solar collector. The two operating states make it possible for the entire heat transfer agent either to be heated in the solar collector or to have heat removed from it in the buffer accumulator. The oscillating operating mode is very efficient especially in combination with hybrid collectors, since one of the functions of the thermal solar collector is to cool the PV module. Because well cooled heat transfer agent comes into contact with the PV module in the second operating state, the driving temperature gradient is especially high.

In an embodiment of the invention, the heat transfer agent is pumped with the pump from the first operating state to the second operating state via the feed line. In this way, the pump can be used in very energy-saving manner, since it can stand still for the rest of the time during the operation of the solar system. On the contrary, in a circulating operating mode of a solar system, the pump runs continuously.

In another embodiment of the invention, the heat transfer agent is transferred from the second operating state to the first operating state by emptying of the thermal solar collector via the feed line. The emptying therefore requires no additional energy. The self emptying can be realized in that the feed line is situated at the lowest point of the thermal solar collector and the highest point of the buffer accumulator is lower than the lowest point of the solar collector.

It has proven to be advisable for the heat transfer agent depending on its temperature to be pumped via the feed line to the thermal solar collector or taken via the feed line to the buffer accumulator. The feed line can also be utilized by the present operating mode for the feeding and draining of the heat transfer agent. Therefore, no additional lines are needed.

Advisedly, the pump stands in contact with the heat transfer agent independently of the first and the second operating state. This prevents the pump from running dry. This maintenance requirement is easy to realize by situating the pump lower than the highest point of the heat transfer agent located in the buffer accumulator.

It has proven to be advisable for the heat transfer agent to be taken from the thermal solar collector to the buffer accumulator via a bypass line, which bypasses the pump. In this way, the solar collector can be emptied by simply opening a valve. The pump is not required for the emptying.

The method is free from a circulating movement of the heat transfer agent, since the heat transfer agent is taken oscillating back and forth via the feed line between the thermal solar collector and the buffer accumulator. The system may therefore be operated pressureless. The formation of dead zones is reliably prevented, since the solar collector is completely emptied upon switching to the first operating state.

Advisedly, the hybrid collector solar system is operated pressureless, which as already explained above brings major advantages especially for hybrid collectors.

It is advantageous when a residual volume of heat transfer agent remains in the buffer accumulator in the second operating state. In this way, the pump runs no danger of running dry. The residual volume in the buffer accumulator can also be formed by the overflow which arises when the heat transfer agent expands in the solar collector.

A further aspect of the invention also relates to a hybrid collector solar system to carry out the above described method. It is desirable for the volume capacity of the solar system for the heat transfer agent to be at least twice as large as the volume of the heat transfer agent filled into it. This dimensioning of the solar system means that the oscillating mode of operation can be realized. The heat transfer agent is situated almost entirely either in the thermal solar collector or in the buffer accumulator. The heat-up phase and the heat removal phase are therefore separate from each other and occur in sequence.

Advisedly, the volume of the solar system free of the heat transfer agent is filled with air. As a result, the heat transfer agent can expand in the solar collector without building up a pressure in the solar system.

In one embodiment of the invention, the fill volume of the buffer accumulator contains at least the volume of the heated heat transfer agent. In this way, the heat transfer agent can be contained entirely in the buffer accumulator in the first operating state, where the heat is removed from the entire heat transfer agent.

In another embodiment of the invention, the fill volume of the thermal solar collector at most contains the volume of the cooled-down heat transfer agent. This ensures that the solar collector is filled entirely with the heat transfer agent in the second operating state and the entire heat transfer agent is heated up.

Advisedly, the thermal solar collector is connected by the feed line and an overflow line to the buffer accumulator. The overflow line serves for returning to the buffer accumulator the expanding heat transfer agent during the second operating state, which cannot be accommodated in the solar collector. The return of the heat transfer agent after the close of the second operating state occurs spontaneously via the feed line.

In another embodiment of the invention, the thermal solar collector is self-emptying. It requires no additional energy to completely empty the solar collector and fill the buffer accumulator.

### BRIEF DESCRIPTION OF THE DRAWINGS

Further advantages and features will emerge from the following description of an exemplary embodiment making reference to the schematic representations. There are shown, in a representation not drawn true to scale:

FIG. 1 is a hybrid collector solar system in a first operating state;

FIG. 2 is the hybrid collector solar system in a second operating state; and

FIG. 3 is the hybrid collector solar system after the return of the heat transfer agent to the first operating state.

### DETAILED DESCRIPTION

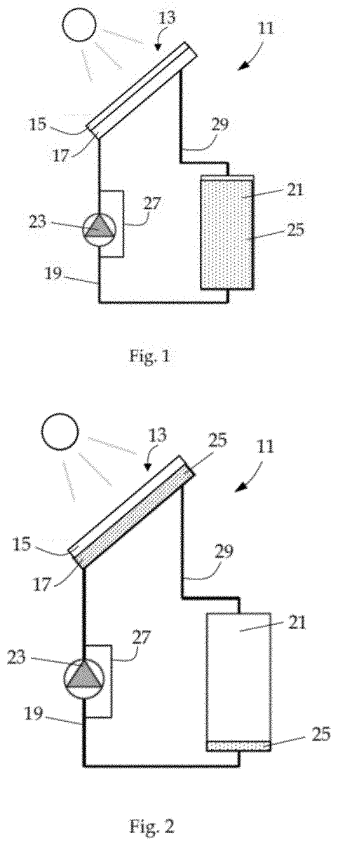

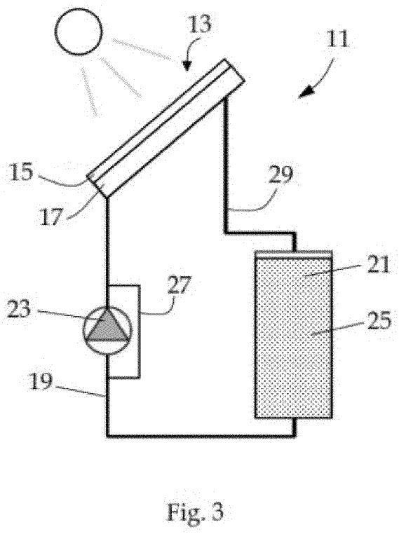

FIGS. 1 to 3 show a hybrid collector solar system, indicated as a whole by reference number 11. The core of the solar system is a hybrid collector 13. The hybrid collector 13 comprises a photovoltaic module (PV module) 15, which is arranged on a thermal solar collector 17. The PV module 15 comprises a plurality of solar cells, which are held between two glass plates. The thermal solar collector 17 is formed in that a seal is compressed between the PV module 15 and a plate and the seal spaces the plate apart from the PV module 15. The plate is held by clamps, braces or screws on the PV module 15. The hybrid collector 13 is fluidically connected by a feed line 19 to a buffer accumulator 21. A pump 23 is integrated in the feed line 19 and can pump a heat transfer agent 25 from the buffer accumulator 21 to the thermal solar collector 17.

The solar system 11 is not filled entirely with the heat transfer agent 25, but rather a portion of the solar system is unfilled. The fill volume of the heat transfer agent 25 is at least as large as the volume of the thermal solar collector 17. This ensures that the thermal solar collector 17 can be filled entirely with the heat transfer agent 25 and as much heat as possible can be transferred to the heat transfer agent.

FIG. 1 shows a first operating state in which the heat transfer agent 25 is located in the buffer accumulator 21. The heat taken up in the solar collector 17 is removed from the heat transfer agent 25 in the buffer accumulator 21, for example by a heat exchanger integrated in the buffer accumulator 21. The fill volume of the buffer accumulator 21 is dimensioned such that the heated heat transfer agent 25 at its maximum expansion is accommodated in the buffer accumulator. Because the heat transfer agent 25 is entirely taken up in the buffer accumulator 21, the heat can be removed from the entire heat transfer agent 25 in the buffer accumulator 21. In addition, the feed line 19 must be filled with heat transfer agent 25 up to the pump 23 so that the pump 23 does not run dry and so that it can draw the heat transfer agent 25. Advisedly, the pump 23 is situated at a level which lies below the liquid surface of the heat transfer agent 25 in the first operating state. In this way, heat transfer agent 25 is forced into the pump 23.

After the heat has been removed from the heat transfer agent 25 in the buffer accumulator 21, the heat transfer agent is pumped by the pump 23 via the feed line 19 to the thermal solar collector 17. The heat transfer agent 25 remains in the solar collector 17 until a defined temperature or a defined time interval has been reached. In this second operating state (FIG. 2), the thermal solar collector 17 is entirely filled with the heat transfer agent. A small amount of heat transfer agent 25 may remain in the buffer accumulator 21 so as to have a reserve. The entire heat transfer agent 25 is heated up in the thermal solar collector 17 by the solar radiation until the necessary temperature for the operation of the solar system 11 has been reached.

The solar system 11 can be operated pressureless, since it is not filled entirely with heat transfer agent 25. The residual volume of the solar system 11 is free of the heat transfer agent 25 and therefore is filled with air. In this way, the heat transfer agent 25 can expand without resistance during the heating. This is of special advantage for a hybrid collector solar system 11, since the photovoltaic module 15 may comprise at least one pressure-sensitive glass plate.

The pump 23 is not constantly in operation as in a circulating mode of operation, when the heat transfer agent 25 is pumped constantly in a circuit. Instead, the pump 23 is only switched on when changing between the first operating state and the second operating state and the pump 23 pumps the heat transfer agent 25 from the buffer accumulator 21 to the thermal solar collector 17. In this way, the pump 23 in the present method can be operated in especially energy-saving manner, so that the overall efficiency of the solar system 11 is improved.

In the next step, a bypass line 27 is opened, which bypasses the pump 23. Because the solar collector 17 is arranged higher than the buffer accumulator 21 and at a slant, the solar collector 17 is emptied spontaneously and completely. For the emptying of the solar collector 17, therefore the pump 23 does not need to be placed in operation. The buffer accumulator 21 is spontaneously filled by gravity with the heated heat transfer agent 25. After the filling of the buffer accumulator 21, the heat can be removed from the heat transfer agent 25.

In addition, the thermal solar collector 17 is connected to the buffer accumulator 21 by an overflow line 29. In this way, the heat transfer agent 25 expanding in the thermal solar collector during the heating can flow back to the buffer accumulator via the overflow line 29. The overflow line makes it possible for the heat transfer agent 25 to expand without building up a pressure in the solar system 11.

The present method of operating the hybrid collector solar system 11 makes it possible for the heat transfer agent 25 to oscillate back and forth between the thermal solar collector 17 and the buffer accumulator 21. Surprisingly, the inventor has discovered that this mode of operation results in a boosting of the overall efficiency as compared to a circulating mode of operation. In order to realize the oscillating mode of operation, the fill volume of the thermal solar collector 17 is dimensioned such that it corresponds at most to the volume of the cooled heat transfer agent 25. In this way, the thermal solar collector 17 can always be filled completely with the heat transfer agent 25. Thanks to the complete emptying of the thermal solar collector 17 upon ending the second operating state, the formation of dead zones can be prevented, such as are often formed in a solar collector with a circulating mode of operation.

The fill volume of the buffer accumulator 21 is dimensioned such that it corresponds at least to the volume of the heated heat transfer agent 25. In this way, the entire heated heat transfer agent 25 can be taken up in the buffer accumulator 21 and can surrender its heat there.

1-16. (canceled)

17. A method for operating a hybrid collector solar system, comprising:
partially filling the hybrid collector solar system with a heat transfer agent so that part of the solar system is not filled;
passing the heat transfer agent, which is present in a buffer accumulator, via a pump into a thermal solar collector to heat the heat transfer agent, the pump connected to a feed line that connects the buffer accumulator to the thermal solar collector; and
moving the heat transfer agent back and forth between the thermal solar collector and the buffer accumulator via the feed line depending on a temperature of the heat transfer agent to provide an oscillating method of operation.

18. The method of claim 17, wherein the heat transfer agent in a first operating state is primarily located in the buffer accumulator and in a second operating state it is primarily located in the thermal solar collector.

19. The method of claim 18, further comprising pumping the heat transfer agent with the pump from the buffer accumulator to the thermal solar collector via the feed line.

20. The method of claim 18, further comprising transferring the heat transfer agent from the second operating state to the first operating state by emptying the thermal solar collector via the feed line.

21. The method of claim 17, further comprising pumping the heat transfer agent depending on its temperature via the feed line to the thermal solar collector or taken via the feed line to the buffer accumulator.

22. The method of claim 18, wherein the pump stands in contact with the heat transfer agent independently of the first and the second operating state.

23. The method of claim 17, further comprising taking the heat transfer agent from the thermal solar collector to the buffer accumulator via a bypass line, which bypasses the pump.

24. The method of claim 17, further comprising preventing a circulating movement of the heat transfer agent by oscillating the heat transfer agent back and forth via the feed line between the thermal solar collector and the buffer accumulator.

25. The method of claim 17, further comprising operating the hybrid collector solar system pressureless.

26. The method of claim 18, wherein a residual volume of the heat transfer agent remains in the buffer accumulator in the second operating state.

27. A hybrid collector solar system, comprising:
a thermal solar collector;
a photovoltaic module arranged on the thermal solar collector, the photovoltaic module and the thermal solar collector together forming the hybrid collector solar system;
a heat transfer agent within the hybrid collector solar system, a volume capacity of the hybrid collector solar system for the heat transfer agent being at least twice as large as a volume of the heat transfer agent within the hybrid collector solar system;
a buffer accumulator in fluid communication with the hybrid collector via a feed line; and
a pump connected into the feed line.

28. The solar system of claim 27, wherein a free volume of the hybrid collector solar system free of the heat transfer agent is filled with air.

29. The solar system of claim 27, wherein a fill volume of the buffer accumulator contains at least the volume of the heat transfer agent in a heated state.

30. The solar system of claim 27, wherein a fill volume of the thermal solar collector at most contains the volume of the heat transfer agent in a cooled-down state.

31. The solar system of claim 27, wherein the thermal solar collector is connected by the feed line and an overflow line to the buffer accumulator.

32. The solar system of claim 27, wherein the thermal solar collector is self-emptying.
